(19) United States
(12) Patent Application Publication
(10) Pub. No.: US 2015/0191555 A1
(43) Pub. Date: Jul. 9, 2015

(54) METHOD FOR MODIFYING UNSATURATED HYDROCARBON RESIN

(71) Applicants: COMPAGNIE GENERALE DES ETABLISSEMENTS MICHELIN, Clermont-Ferrand (FR); MICHELIN RECHERCHE ET TECHNIQUE, S.A., Granges-Paccot (CH)

(72) Inventor: Philippe Laubry, Clermont-Ferrand (FR)

(73) Assignees: MICHELIN RECHERCHE ET TECHNIQUE, S.A., Granges-Paccot (CH); COMPAGNIE GENERALE DES ETABLISSEMENTS MICHELIN, Clermont-Ferrand (FR)

(21) Appl. No.: 14/412,470

(22) PCT Filed: Jun. 24, 2013
(86) PCT No.: PCT/EP2013/063138

§ 371 Date: Jan. 2, 2015

(30) Foreign Application Priority Data
Jul. 5, 2012 (FR) 1256461

(51) Int. Cl. C08F 8/20; C08F 8/06

(52) U.S. Cl. CPC C08F 8/20; C08F 8/06

(57) ABSTRACT

A method for modifying a resin which comprises the reaction of an unsaturated resin consisting of more than 95% by mass of carbon and hydrogen atoms with a hypohalogenous compound in at least one solvent in the presence of a hydroxylated compound. This method results in the synthesis of new resins having oxygenated and halogenated functions.

This application is a 371 national phase entry of PCT/EP2013/063138, filed 24 Jun. 2013, which claims benefit of French Patent Application No. 1256461, filed 5 Jul. 2012, the entire contents of which are incorporated herein by reference for all purposes.

### BACKGROUND 1. Field

The present disclosure relates to the synthesis of resins by modifying essentially hydrocarbon resins.

2. Description of Related Art

The essentially hydrocarbon resins are thermoplastic polymers well known to a person skilled in the art, essentially based on carbon and hydrogen but possibly comprising other types of atoms. They are extensively described in the work with the title “Hydrocarbon Resins” by R. Mildenberg, M. Zander and G. Collin (New York, VCH, 1997, ISBN 3-527-28617-9). They may be aliphatic, notably cycloaliphatic, or aromatic. The resins may be of natural origin such as rosin or terpene resins extracted respectively from resinous trees or from oranges. The resins may be of synthetic origin, for example the C₅ resins, the C₉ resins or the coumarone indene resins.

The resins mentioned above may be used as additives in polymer compositions for modulating the properties of the compositions. For example patents U.S. Pat. No. 5,901,766 and U.S. Pat. No. 7,084,228 give an illustration of their use in rubber compounds for tyres and their effect on the performance of tyres containing such compositions.

To broaden the range of available resins, there have been attempts to modify the chemical structure of existing resins to change their properties such as their reactivity, their polarity, the level of unsaturated bonds in the resin, and consequently modulate the properties of polymer compositions containing them.

Thus, the resins obtained from the C₅ or C₉ petroleum cut have been “modified” by the copolymerization of monomers from one petroleum cut (C₅ or C₉) with at least one other monomer that has not been obtained from the same petroleum cut. These are for example resins of copolymers of C₅ cut/C₉ cut, copolymers of C₅ cut/styrene or copolymer of C₉ cut/indene. It is also known to modify the resins using phenol as comonomer notably for synthesizing terpene phenol or acetylene phenol resins. These resin modifications take place during the actual synthesis of the resin. However, chemical modification may be carried out once the resin has been synthesized. This is notably the case with resins modified by hydrogenation, for example the dicyclopentadiene resins or the C₉ resins modified by hydrogenation, as described in patent U.S. Pat. No. 6,458,902.

### SUMMARY

The applicants have discovered the synthesis of novel resins whose polarity and glass transition temperature are increased without degrading the macrostructure of the original resin, by a simple method that can be applied to a great variety of essentially hydrocarbon resins.

The invention, in an embodiment, relates to a modified resin and the method for preparing it.

More precisely the invention, in an embodiment, relates to a method for modifying a resin that comprises reaction of an unsaturated resin consisting to more than 95 wt % of carbon and hydrogen atoms with a hypohalogenous compound in at least one solvent in the presence of a hydroxylated compound.

The invention, in an embodiment, also relates to a modified resin that comprises the reaction product obtained by the method as defined above.

The invention and its advantages will be easily understood in light of the description and embodiment examples that follow.

### I—DETAILED DESCRIPTION OF SPECIFIC EMBODIMENTS OF THE INVENTION

In the present description, unless expressly stated otherwise, all the percentages (%) shown are wt %.

Moreover, any range of values denoted by the expression “between a and b” represents the domain of values from more than “a” to less than “b” (i.e. limits a and b excluded) whereas any range of values denoted by the expression “from a to b” signifies the domain of values from “a” up to “b” (i.e. including the strict limits a and b).

According to an embodiment of the invention, the resin to be modified, whether of natural or synthetic origin, is an unsaturated resin, i.e. it comprises carbon-carbon bonds that are not saturated, such as double bonds, and that are reactive. That is why the resin to be modified is preferably characterized by an iodine number greater than 50, more preferably between 50 and 200, even more preferably between 65 and 180.

The resin to be modified desirably has more than 95 wt % of carbon and hydrogen atoms. The complement to 100% consists of heteroatoms, preferably oxygen atoms. Among the resins based on carbon, hydrogen and oxygen, we may mention the colophony resins, the terpene phenol resins and the acetylene phenol resins.

According to a preferred embodiment of the invention, the resin to be modified is a hydrocarbon resin consisting to more than 99% of carbon and hydrogen. As examples of such hydrocarbon resins, we may mention those selected from the group consisting of the homopolymer or copolymer resins of cyclopentadiene (abbreviated to CPD), the homopolymer or copolymer resins of dicyclopentadiene (abbreviated to DCPD), the homopolymer or copolymer resins of terpene, the resins based on a C₅ cut. Among the above copolymer resins, we may mention more particularly those selected from the group consisting of the resins of (D)CPD/vinylaromatic copolymer, the resins of (D)CPD/terpene copolymer, the resins of (D)CPD/C₅ cut copolymer, the resins of (D)CPD/C₉ cut copolymer, the resins of terpene/vinylaromatic copolymer, the resins of C₅ cut/vinylaromatic copolymer, and the mixtures of these resins. The term “terpene” includes, as is known, the alpha- pinene, beta-pinene and limonene monomers; a limonene monomer is preferably used, which is a compound that occurs, as is known, in the form of three possible isomers: L-limonene (laevorotatory enantiomer), D-limonene (dextrorotatory enantiomer), or else dipentene, racemic mixture of the dextrorotatory and laevorotatory enantiomers. For example styrene, alpha-methylstyrene, ortho-methylstyrene, meta-methylstyrene, para-methylstyrene, vinyl-toluene, para-tert-butylstyrene, vinylmesitylene, and any vinylaromatic monomer derived from a C₉ cut (or more generally from a C₈ to C₁₀ cut), are suitable as vinylaromatic monomer.

All the above resins are well known to a person skilled in the art and are available commercially, being sold for example by the company DRT under the name “Dercolyte” with regard to the polylimonene resins, by the company Neville Chemical Company under the name “Super Nevtac”, by Kolon under the name “Hikorez” or by the company Exxon Mobil under the name “Escorez” with regard to the C₅ cut/styrene resins or resins of C₅ cut/C₉ cut copolymer.

According to a more preferred embodiment of the invention, the resin to be modified is a polylimonene resin.

According to another more preferred embodiment of the invention, the resin to be modified is a resin based on a C₅ cut, notably a resin of C₅ cut or of C₅ cut/C₉ cut copolymer.

The resin to be modified preferably has a number-average molecular weight in a range from 400 to 2000 g/mol, and a glass transition temperature above 20° C., more preferably between 20 and 160° C., even more preferably between 30 and 100° C.

According to an embodiment of the invention, the resin to be modified is dissolved in a solvent that solubilizes the resin. The solvent is aromatic, for example toluene, or aliphatic, for example heptane, methylcyclohexane. The solvent may be a mixture of these aforementioned solvents.

According to an embodiment of the invention, the hydroxylated compound in the presence of which the reaction of modification of the resin takes place is an alcohol, water or mixture thereof. The water may come from traces that are present in the solvent that solubilizes the resin or in the alcohol that is the hydroxylated compound in the presence of which the reaction of modification takes place. The hydroxylated compound is preferably an alcohol, in particular an alcohol of a C₁-C₅ alkane or benzyl alcohol.

According to an embodiment of the invention, the hypohalogenous compound that reacts with the resin to be modified may be a hypohalogenous acid (HOX where X is halogen) or an ester of a hypohalogenous acid.

Among the hypohalogenous compounds, the hypochlorous compounds are preferred, whether of the acid or ester form.

Among the esters of hypohalogenous acid, we may mention the alkyl hypohalogenites (ROX) with the alkyl radical R preferably being of C₁-C₅, of benzyl (PhCH₂OX) or mixtures thereof.

According to a preferred embodiment, the ester of the hypohalogenous acid is an alkyl hypochlorite, more preferably methyl hypochlorite.

According to a particularly preferred embodiment of the invention, the hypohalogenous compound is formed by contact of an N-haloamide compound with the hydroxylated compound. This embodiment is advantageous, as it allows in-situ synthesis of the halogenous compound and use thereof without having to isolate it from the medium in which it is formed, which makes it easier to use hypohalogenous compounds with known chemical instability, for example methyl hypochlorite. If the hydroxylated compound is an alcohol, the hypohalogenous compound formed is an ester of hypohalogenous acid. If the hydroxylated compound is water, the hypohalogenous compound formed is a hypohalogenous acid. If the compound is a mixture of alcohol and water, notably in the case when the alcohol contains traces of water, the hypohalogenous compound formed in situ is a mixture of hypohalogenous ester and hypohalogenous acid.

The N-haloamide compound is preferably a trihaloisocyanuric acid, more preferably trichloroisocyanuric acid. In place of the acid, it is possible to use the sodium salt of dichloroisocyanuric acid as N-haloamide compound.

The N-haloamide compound is dissolved preferably in a ketone for example acetone, methyl ethyl ketone or an ester for example ethyl acetate or butyl acetate.

According to a particular form of this particularly preferred embodiment of the invention, the solution containing the N-haloamide compound is added to the solution containing the resin and the hydroxylated compound. It is during contacting of these two solutions that the hypohalogenous compound forms in situ, which reacts with the unsaturated bonds of the resin to be modified.

According to another particular form of this particularly preferred embodiment of the invention, the hydroxylated compound is added beforehand to the solution containing the N-haloamide compound, or vice versa. This addition beforehand has the effect of forming the hypohalogenous compound in situ before it is brought into contact with the resin to be modified.

According to these two particular embodiments, preferably an alcohol is used, more preferably of C₁-C₃ for example methanol, ethanol, normal propanol or isopropanol, even more preferably methanol as hydroxylated compound, the alcohol possibly containing traces of water, and trichloroisocyanuric acid as N-haloamide compound.

The solvent in which the reaction of modification of the resin takes place contains at least the solvent that solubilizes the resin. It may be supplemented with a different solvent, which may be used for dissolving the hypohalogenous compound, or if applicable the N-haloamide compound, before it is brought into contact with the resin to be modified.

According to a preferred embodiment of the invention that applies to the embodiments described above, the modification reaction is carried out in a single-phase medium. Single-phase medium means a medium that consists of all of the liquids present in the reaction mixture and that forms a single liquid phase. A person skilled in the art knows how to select the nature of the solvents and their proportion as a function of their polarity to obtain a single-phase medium.

The joint use of a single-phase medium and trichloroisocyanuric acid for generating the hypohalogenous compound in situ has the advantage of simplifying the processing of the reaction mixture at the end of the resin modification reaction to isolate the modified resin at a yield approaching 100%, and this constitutes a quite particularly preferred embodiment of the invention. In fact at the end of the reaction, the reaction by-product isocyanuric acid is easily removed by simple filtration of the reaction mixture.

In order to control the exothermic effect resulting from contacting the hypohalogenous compound or if applicable the N-haloamide compound with the solution of the resin to be modified, it is preferable to add dropwise a solution of the hypohalogenous compound or if applicable of the N-haloamide compound to the solution of resin to be modified maintained at room temperature. The concentration of reactants in the solutions, namely the resin to be modified, the hypohalogenous compound or if applicable the N-haloamide compound, and the hydroxylated compound, is adjusted as a function of the solubility of the reactants in the solvents used. It may vary from 10 to 50%. It is advantageously about 30%. In these conditions of dropwise addition and of concentration, the reaction temperature does not exceed the reflux temperature. After bringing the reactants in contact, the reaction mixture for modifying the resin to be modified is preferably refluxed up to the end of the reaction, determined by complete consumption of at least one of the reactants or by maximum conversion of the unsaturations of the resin to be modified. Nevertheless, it is desirable not to exceed 150° C. in the reaction mixture so as not to degrade the original macrostructure of the resin before modification.

The stoichiometry with respect to hypohalogenous compound or if applicable with respect to N-haloamide compound is adjusted as a function of the chemical nature of the unsaturations of the resin to be modified, the iodine number of the resin to be modified and the intended polarity of the modified resin. It is generally in a range from 3 to 9 equivalents of chlorine atom per 1 kg of resin.

The hydroxylated compound is preferably in stoichiometric excess relative to the hypohalogenous compound or if applicable the N-haloamide compound.

The method according to an embodiment of the invention described above allows the chemical structure of a resin to be modified by introducing oxygen and halogen atoms, in particular chlorine atoms, into the resin. This modification, which makes it possible to increase the polarity of the resin and its glass transition temperature, is reflected in a decrease in the iodine number of the resin. After modification, the iodine number is generally above 40 and in particular is between 40 and the value of the iodine number of the resin before modification.

The preferential aspects of the embodiments of the invention described may be combined with one another.

The aforementioned characteristic features of the present invention, and others, will be better understood on reading the following description of several embodiment examples of the invention, given for purposes of illustration, and not limiting.

### II—EMBODIMENT EXAMPLES OF THE INVENTION

Measurements Used:

Iodine number: the iodine number of the resins is determined by iodometry using Wijs reagent (iodine chloride in acetic acid) and is expressed in gram of iodine absorbed per 100 g of resin.

Chlorine level: determination of chlorine is performed by argentometry after mineralization of the resins by Schöniger combustion; the chlorine level is expressed in gram of Cl atom per 100 g of resin.

Oxygen level: the oxygen content is measured by elemental analysis using a CHNS-O microanalyser model flash EA-1112 by pyrolysis of the samples under a helium/oxygen stream with gas chromatography analysis of the gases formed; the oxygen level is expressed in gram of O atom per 100 g of resin.

Glass transition temperature: the glass transition temperature of the resins is measured using a differential scanning calorimeter according to standard ASTM D3418 (1999).

Number-average molecular weight Mn and polydispersity index PDI: the macrostructure is determined by size exclusion chromatography (SEC) as indicated below. As a reminder, SEC analysis, for example, consists of separating the macromolecules in solution according to their size through columns filled with a porous gel; the molecules are separated according to their hydrodynamic volume, the most voluminous being eluted first. The sample to be analysed is simply dissolved beforehand in a suitable solvent, tetrahydrofuran at a concentration of 1 g/l. Then the solution is filtered on a filter of porosity 0.45 μm, before injection into the apparatus. The apparatus used is for example a “Waters alliance” chromatographic chain according to the following conditions:
elution solvent is tetrahydrofuran,
temperature 35° C.;
concentration 1 g/l;
flow rate: 1 ml/min;
volume injected: 100 μl;
Moore calibration with polystyrene standards;
set of 3 “Waters” columns in series (“Styragel HR4E”, “Styragel HR1” and “Styragel HR 0.5”);
detection by differential refractometer (for example “WATERS 2410”), which may be equipped with operating software (for example “Waters Millenium”).

A Moore calibration is carried out with a series of commercial polystyrene standards with low PDI (below 1.2), of known molecular weights, covering the range of molecular weights to be analysed. The following are deduced from the data recorded (weight-based distribution curve of the molecular weights): the weight-average molecular weight (Mw), the number-average molecular weight (Mn), and the polydispersity index (PDI=Mw/Mn). All the values of molecular weights stated in the present application are therefore relative to calibration curves determined with polystyrene standards.

Examples of Synthesis of Modified Resin:

Unless stated otherwise, the procedure used is as follows:

A solution of trichloroisocyanuric acid (TIC) is prepared from 15 g of TIC and 50 ml of acetone. A solution of resin to be modified is prepared from 50 g of resin to be modified, 130 ml of toluene and 20 ml of methanol. The colourless solution of TIC is added dropwise over the course of 15 minutes to the yellow coloured solution of resin to be modified, which is at room temperature (20° C.). This addition causes precipitation of the by-product, isocyanuric acid, in the single-phase liquid phase of the reaction mixture, which is brown in colour. On completion of addition, the reaction mixture is refluxed for 1 hour, the temperature of the reaction mixture being 65° C. The green coloured reaction mixture is then filtered to remove the precipitate. The organic filtrate is then washed with water until the pH of the wash water is neutral (i.e. 3 to 4 washings with 250 ml of water per washing). After decanting and removal of the aqueous phase, the solvents are removed from the organic phase firstly by distillation at atmospheric pressure, the temperature of the medium containing the resin not exceeding 150° C., then by distillation at 160° C. under high vacuum for 10 to 15 minutes. The vacuum distillation is carried out applying a light nitrogen stream. Finally the hot resin is transferred to an aluminium boat. The cooled resin is weighed to determine the yield by weight.

The characteristics of the resins to be modified are presented in Table 1. The polylimonene resin and the resin of the C₅ cut/C₉ cut copolymer are commercial resins of the companies DRT and ExxonMobil respectively.

TABLE 1

| | | | | | | Iodine |
|---|---|---|---|---|---|---|
| | Tg | | | Cl | O | number |
| Resin | (° C.) | Mn | PDI | (%) | (%) | (g/100 g) |
| Polylimonene | 71 | 619 | 1.7 | <0.2 | 0.6 | 110 |
| C5/C9 resin | 42 | 853 | 1.9 | <0.2 | 0.4 | 96 |

These 2 resins were modified in the conditions of tests 1 to 8. The amount of TIC, expressed in equivalent of Cl⁺ion per kg of resin to be modified, and any change of condition from the procedure described above are shown in Table 2, together with the characteristics Tg, Mn, PDI, chlorine level and oxygen level of the modified resins.

TABLE 2

| | | | | | | | | Iodine |
|---|---|---|---|---|---|---|---|---|
| | Resin to be | | Tg | Mn | | | | number |
| Test | modified | TIC | (° C.) | (g/mol) | PDI | Cl (%) | O (%) | (g/100 g) |
| 1 | Polylimonene | 3.87 | 82 | 670 | 1.7 | 6.1 | nd | nd |
| 2 | Polylimonene | 3.87 | 83 | 665 | 1.6 | 6.0 | 1.5 | 73 |
| 3 | Polylimonene | 0 | 72 | 628 | 1.6 | nd | nd | nd |
| 4 | C5/C9 resin | 3.87 | 68 | 925 | 2.0 | 9.1 | 1.9 | 51 |
| 5 | C5/C9 resin | 5.16 | 68 | 930 | 1.9 | 10.4 | 1.9 | nd |
| 6 | C5/C9 resin | 6.45 | 70 | 945 | 2.0 | 13.0 | 2.0 | nd |
| 7 | C5/C9 resin | 7.74 | 72 | 940 | 1.9 | 11.3 | 2.0 | nd |
| 8 | C5/C9 resin | 0 | 43 | 851 | 1.9 | nd | 0.4 | nd |

nd: not determined

for test 2: all the amounts of the reactants and solvents were doubled.

For tests 5, 6 and 7, TIC is not dissolved in 50 ml of acetone, but in 60, 65 and 75 ml of acetone respectively and the volumes of toluene and of methanol were adjusted respectively to 240, 260 and 300 ml to keep the volume ratio toluene/methanol/acetone constant at 65/10/25 for all the tests.

Tests 1, 2 and 4-7 are according to the invention.

Tests 3 and 8 correspond to treatment similar to the other tests except that TIC is not used. These tests are able to show that the resin, in the absence of TIC and despite the thermal treatments, does not undergo any change from the standpoint of its chemistry and its macrostructure, since the values of Mn, PDI and oxygen level are unchanged relative to the starting resin. The changes observed in the other tests in which TIC was used can be attributed to the reaction of modification of the resin according to the invention.

The reaction of modification of the polylimonene resin according to test 1 has the effect of increasing the glass transition temperature of the resin by 11 degrees, and of introducing the chlorinated and oxygenated functions into the resin without altering the macrostructure of the polylimonene resin, since the PDI value is almost identical. The increase in the value of Mn reflects the molecular weight increase of the resin owing to introduction of the chlorinated and oxygenated functions into the resin.

Doubling the amounts of the reactants and solvents in test 2 while otherwise keeping the conditions identical does not have the effect of altering the result of the modification reaction. This test 2 demonstrates the immediate extrapolation of the method to a larger scale as well as the reproducibility of the method despite the change of scale. The decrease in the iodine number from 110 to 73 reflects the fact that the reaction of modification by the chlorine and oxygen atoms affects the unsaturated carbon-carbon bonds of the polylimonene resin.

Tests 4 to 7 were carried out on a resin of C₅ cut/C₉ cut copolymer. Tests 4 to 7 differ from one another in that the stoichiometry of TIC varies. The more the stoichiometry of TIC increases, the more the Tg value of the modified resin and the overall level of chlorine and oxygen in the modified resin increase, almost reaching an asymptotic value. It is noted that the macrostructure has not degraded, since the PDI value is constant and the increase in the value of Mn reflects the increase in molecular weight through incorporation of chlorinated and oxygenated functions in the resin.

For all the tests from 1 to 8, the yield of resin is quantitative. The iodine number, when it was measured, shows that the modified resin retains a certain level of unsaturated carbon-carbon bonds. Although the iodine number was not measured for tests 5 to 7, the iodine number must reach a non-zero threshold value since the evolution of the overall level of chlorine and oxygen in the resin tends to an asymptote. This means that there are still unsaturated carbon-carbon bonds in the modified resin, which always confers an unsaturated character on the modified resin.

To summarize, tests 1 to 8 show that the method according to an embodiment of the invention is reproducible, can be extrapolated to a larger scale, is applicable to a great variety of essentially hydrocarbon resins and is simple to carry out owing to the number of steps and their nature (addition, filtration, washing, distillation). It leads to a modified resin at a quantitative yield. Both the polarity and the glass transition temperature of the modified resin are increased by the introduction of chlorinated and oxygenated functions without degradation of the original macrostructure. The resin partly retains its unsaturated character.

Based on its polarity and its glass transition temperature, a resin according to an embodiment of the invention may be used in polymer compositions for modifying their chemical and mechanical properties. It constitutes an alternative to the unmodified resins already known.

1. A method for modifying a resin, which comprises reaction of an unsaturated resin having more than 95 wt % of carbon and hydrogen atoms with a hypohalogenous compound in at least one solvent in the presence of a hydroxylated compound.

2. The method according to claim 1, wherein the unsaturated resin has a number-average molecular weight in a range from 400 to 2000 g/mol and a glass transition temperature above 20° C.

3. The method according to claim 1, wherein the unsaturated resin has more than 99 wt % of carbon and hydrogen atoms.

4. The method according to claim 3, wherein the unsaturated resin is a polylimonene resin.

5. The method according to claim 3, wherein the unsaturated resin is a resin based on a C5 cut.

6. The method according to claim 1, wherein the hypohalogenous compound is a hypohalogenous acid or an ester of hypohalogenous acid.

7. The method according to claim 1, wherein the hypohalogenous compound is a hypochlorous compound.

8. The method according to claim 1, wherein the hydroxylated compound is an alcohol.

9. The method according to claim 1, wherein the hydroxylated compound is water or a mixture thereof with an alcohol.

10. The method according to claim 8, wherein the alcohol is methanol.

11. The method according to claim 1, wherein the method comprises reaction of an N-haloamide-(C═O)-N(X) with the hydroxylated compound to synthesize the hypohalogenous compound.

12. The method according to claim 11, wherein the N-haloamide is trichloroisocyanuric acid.

13. The method according to claim 1, wherein the reaction takes place in a reaction mixture whose liquid phase consists of a single phase.

14. A modified resin that comprises the reaction product obtained by the method according to claim 1.

15. The method according to claim 7, wherein the hypohalogenous compound is methyl hypochlorite.
